(19) United States
(12) Patent Application Publication
(10) Pub. No.: US 2026/0142418 A1
(43) Pub. Date: May 21, 2026

(54) ELECTRICAL CONNECTOR WITH SLIDER TO PROTECT TERMINALS

(71) Applicant: DONGGUAN LUXSHARE TECHNOLOGIES CO., LTD, Dongguan City (CN)

(72) Inventors: Tengfang XIONG, Dongguan City (CN); Bin HUANG, Dongguan City (CN); Jie ZHANG, Dongguan City (CN); Kunlin YAO, Dongguan City (CN); Hongji CHEN, Dongguan City (CN); Chenhui ZENG, Dongguan City (CN); Shuangfeng YUAN, Dongguan City (CN)

(73) Assignee: DONGGUAN LUXSHARE TECHNOLOGIES CO., LTD, Dongguan City (CN)

(21) Appl. No.: 19/239,083

(22) Filed: Jun. 16, 2025

(30) Foreign Application Priority Data
Nov. 20, 2024 (CN) 202411670258.2

(51) Int. Cl. H01R 13/64; H01R 13/02; H01R 13/24; H01R 13/504

(52) U.S. Cl. CPC H01R 13/64; H01R 13/025; H01R 13/2457; H01R 13/504

(57) ABSTRACT

An electrical connector includes a housing, a first conductive terminal, a second conductive terminal and a slider. The first conductive terminal includes a first elastic contact arm having a first contact portion. The second conductive terminal includes a second elastic contact arm having a second contact portion. The slider is configured to abut against the first elastic contact arm and the second elastic contact arm when a mating module is inserted into the electrical connector, so that the first elastic contact arm and the second elastic contact arm are elastically deformed, and the first contact portion and the second contact portion are brought into contact with the mating module to achieve electrical connection. By providing the slider, it reduces the risk that the first conductive terminal and the second conductive terminal are easily damaged by foreign matter, thereby improving reliability.

### CROSS-REFERENCE TO RELATED APPLICATION

This patent application claims priority of a Chinese Patent Application No. 202411670258.2, filed on Nov. 20, 2024 and titled “ELECTRICAL CONNECTOR”, the entire content of which is incorporated herein by reference.

### TECHNICAL FIELD

The present disclosure relates to an electrical connector, which belongs to the technical field of connectors.

### BACKGROUND

An electrical connector in the related art includes an insulating body, a plurality of conductive terminals mounted to the insulating body, and a metal shell installed on the insulating body. The plurality of conductive terminals include a plurality of signal terminals. Each conductive terminal includes an elastic contact arm. The elastic contact arm includes a contact portion and a tail portion integrally extending from the contact portion. However, as the requirements for signal transmission quality of electrical connectors continue to increase, the tail portion will produce significant resonance if it is long in size.

Therefore, there is still room for improvement in electrical connectors in the related art.

### SUMMARY

An object of the present disclosure is to provide an improved electrical connector.

The present disclosure adopts the following technical solution: an electrical connector, including: a housing, the housing defining a receiving slot which extends along a first direction and is configured to at least partially receive a mating module; a first terminal module, the first terminal module being at least partially disposed on the housing, the first terminal module including a plurality of first conductive terminals, each first conductive terminal including a first elastic contact arm, the first elastic contact arm including a first contact portion configured to be in contact with the mating module; a second terminal module, the second terminal module being at least partially disposed on the housing, the second terminal module including a plurality of second conductive terminals, each second conductive terminal including a second elastic contact arm, the second elastic contact arm including a second contact portion configured to be in contact with the mating module; the first contact portion and the second contact portion protruding into the receiving slot; and a slider, the slider being located between the first elastic contact arm and the second elastic contact arm, the slider being configured to abut against the first elastic contact arm and the second elastic contact arm when the mating module is inserted into the receiving slot, so that the first elastic contact arm and the second elastic contact arm deform elastically in directions away from each other, and the first contact portion and the second contact portion are brought into contact with the mating module to achieve electrical connection.

The present disclosure also adopts the following technical solution: an electrical connector, including: a housing, the housing defining a receiving slot which extends along a first direction and is configured to at least partially receive a mating module; a first terminal module, the first terminal module being mounted to the housing, the first terminal module including a plurality of first conductive terminals, each first conductive terminal including a first elastic contact arm, the first elastic contact arm including a first contact portion configured to be in contact with the mating module; a second terminal module, the second terminal module being mounted to the housing, the second terminal module including a plurality of second conductive terminals, each second conductive terminal including a second elastic contact arm, the second elastic contact arm including a second contact portion configured to be in contact with the mating module; the first contact portion and the second contact portion being disposed on opposite sides of the receiving slot; a slider, the slider being located between the first elastic contact arm and the second elastic contact arm along a second direction which is perpendicular to the first direction, the slider being configured to abut against the first elastic contact arm and the second elastic contact arm when the mating module is inserted into the receiving slot, so that the first elastic contact arm and the second elastic contact arm deform elastically in directions away from each other, and as a result, the first contact portion and the second contact portion are brought into contact with the mating module to achieve electrical connection; and an elastic element, the elastic element being configured to abut against the slider.

### BRIEF DESCRIPTION OF DRAWINGS

FIG. 1 is a schematic perspective view of a connector assembly in accordance with an embodiment of the present disclosure;

FIG. 2 is a perspective view of FIG. 1 from another angle;

FIG. 3 is a partially exploded perspective view of FIG. 1, in which a first module, a second module and an outer insulating housing of the electrical connector are separated from one another;

FIG. 4 is a top view of the first module and the second module when they are separated from each other;

FIG. 5 is a bottom view of FIG. 4;

FIG. 6 is a front view of the electrical connector in FIG. 1;

FIG. 7 is a partially exploded perspective view of the first module, the second module and a terminal protection device;

FIG. 8 is a further partially exploded perspective view of FIG. 7;

FIG. 9 is a further partially exploded perspective view of FIG. 8;

FIG. 10 is a partially exploded perspective view of the first module;

FIG. 11 is a partially exploded perspective view of the second module;

FIG. 12 is an exploded perspective view of a first housing, a first insulating block and a first ground sheet in FIG. 10 from another angle;

FIG. 13 is an exploded perspective view of a second housing, a second insulating block and a second ground sheet in FIG. 11 from another angle;

FIG. 14 is an exploded perspective view of the terminal protection device;

FIG. 15 is an exploded perspective view of FIG. 14 from another angle;

FIG. 16 is a schematic cross-sectional view of the connector assembly of the present disclosure taken along a certain section, in which a mating module has just been inserted into a mating slot;

FIG. 17 is a schematic cross-sectional view of the connector assembly of the present disclosure taken along another section, in which the mating module has just been inserted into the mating slot;

FIG. 18 is a schematic cross-sectional view of FIG. 17 when the mating module is fully inserted into the mating slot;

FIG. 19 is a partial enlarged view of frame portion B in FIG. 17; and

FIG. 20 is a partially enlarged view of frame portion C in FIG. 18.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

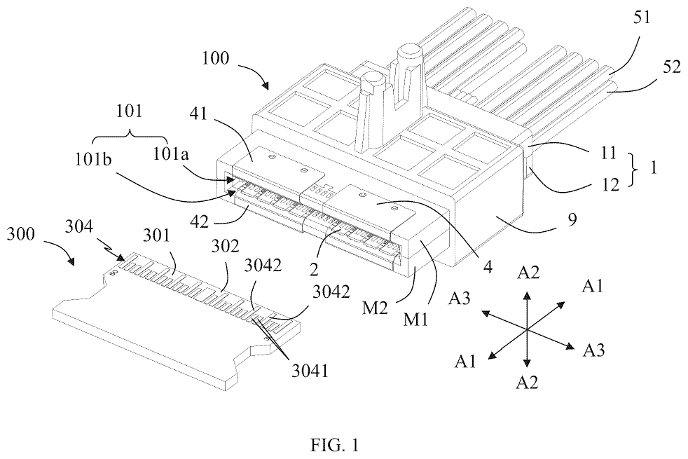

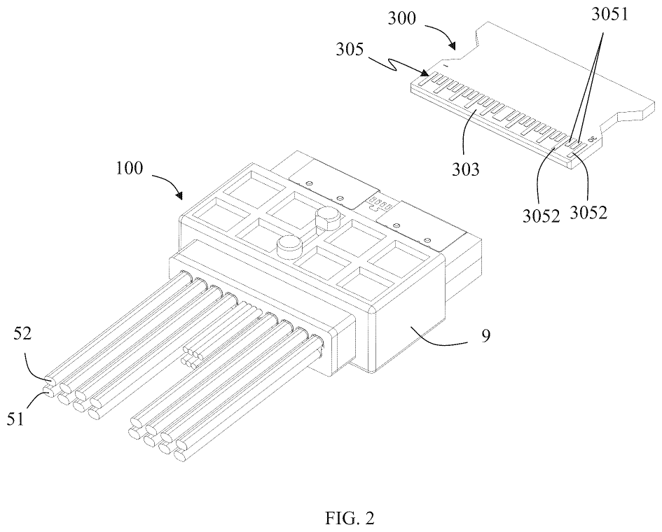

Referring to FIG. 1 and FIG. 2, the present disclosure discloses a connector assembly including an electrical connector 100 and a mating module 300 configured to be at least partially inserted into the electrical connector 100. In the illustrated embodiment of the present disclosure, the electrical connector 100 is an OSFP (Octal Small Form-factor Pluggable) receptacle connector. More specifically, in the illustrated embodiment of the present disclosure, the electrical connector 100 is a receptacle cable connector. Correspondingly, the mating module 300 is an OSFP plug connector. Of course, it is understandable to those skilled in the art that the electrical connector 100 can also be an SFP (Small Form-factor Pluggable) receptacle connector, a QSFP (Quad Small Form-factor Pluggable) receptacle connector, a QSFP-DD (Quad Small Form-factor Pluggable-Double Density) receptacle connector, an SFP-DD (Small Form-factor Pluggable-Double Density) receptacle connector or a DSFP (Dual Chanel Small Form-factor Pluggable) receptacle connector, etc. Correspondingly, the mating module 300 is an SFP plug connector, a QSFP plug connector, a QSFP-DD plug connector, an SFP-DD plug connector or a DSFP plug connector, etc. It is understandable to those skilled in the art that the basic structure of the above types of the electrical connectors 100 is regulated by corresponding association standards, and will not be described in detail here.

Referring to FIG. 1, in the illustrated embodiment of the present disclosure, the electrical connector 100 defines a receiving slot 101 for at least partially receiving the mating module 300. To simplify the description of the specific embodiments of the present disclosure, an insertion and extraction direction of the mating module 300 and the electrical connector 100 is a first direction A1-A1 (for example, a front-rear direction); a thickness direction of the receiving slot 101 is a second direction A2-A2 (for example, a top-bottom direction); a width direction of the receiving slot 101 is a third direction A3-A3 (for example, a left-right direction). Each two of the first direction A1-A1, the second direction A2-A2 and the third direction A3-A3 are perpendicular to each other.

As shown in FIG. 1 and FIG. 2, the mating module 300 includes a tongue plate 301. The tongue plate 301 includes a tongue plate upper surface 302, a tongue plate lower surface 303, a plurality of first contact pads 304 exposed to the tongue plate upper surface 302, and a plurality of second contact pads 305 exposed to the tongue plate lower surface 303. The plurality of first contact pads 304 are disposed at intervals along the third direction A3-A3. The plurality of second contact pads 305 are disposed at intervals along the third direction A3-A3.

Specifically, in the illustrated embodiment of the present disclosure, the plurality of first contact pads 304 include a plurality of first signal contact pads 3041 and a plurality of first ground contact pads 3042. The plurality of first signal contact pads 3041 are divided into a plurality of groups, in which each group includes two first signal contact pads 3041 adjacently arranged along the third direction A3-A3. Each group of first signal contact pads 3041 is associated with two first ground contact pads 3042 which are located on two sides thereof respectively, so as to improve shielding and improve signal transmission quality. In the illustrated embodiment of the present disclosure, each group of first signal contact pads 3041 forms a differential pair to increase the speed of signal transmission. In the illustrated embodiment of the present disclosure, a length of each first ground contact pad 3042 along the first direction A1-A1 is greater than a length of each first signal contact pad 3041 along the first direction A1-A1, so as to better improve the shielding and improve the signal transmission quality.

Similarly, in the illustrated embodiment of the present disclosure, the plurality of second contact pads 305 include a plurality of second signal contact pads 3051 and a plurality of second ground contact pads 3052. The plurality of second signal contact pads 3051 are divided into a plurality of groups, in which each group includes two second signal contact pads 3051 adjacently arranged along the third direction A3-A3. Each group of second signal contact pads 3051 is associated with two second ground contact pads 3052 which are located on two sides thereof respectively, so as to improve shielding and improve signal transmission quality. In the illustrated embodiment of the present disclosure, each group of second signal contact pads 3051 forms a differential pair to increase the speed of signal transmission. In the illustrated embodiment of the present disclosure, a length of each second ground contact pad 3052 along the first direction A1-A1 is greater than a length of each second signal contact pad 3051 along the first direction A1-A1, so as to better improve the shielding and improve the signal transmission quality.

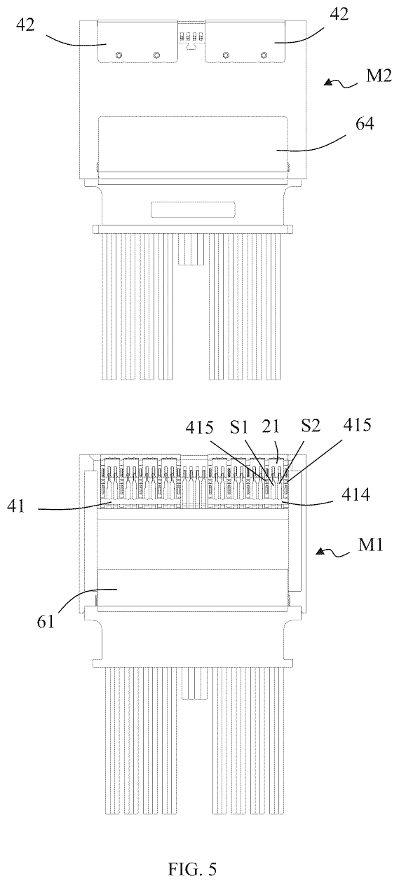

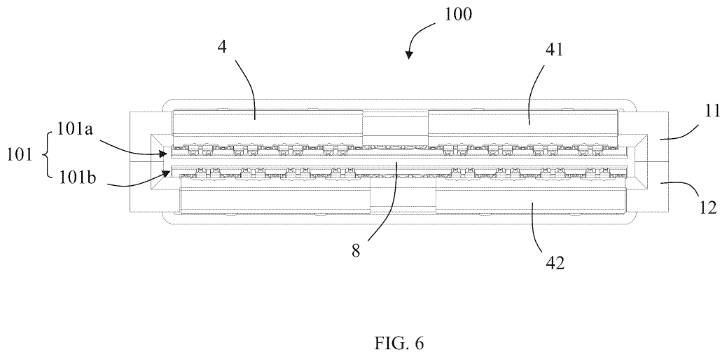

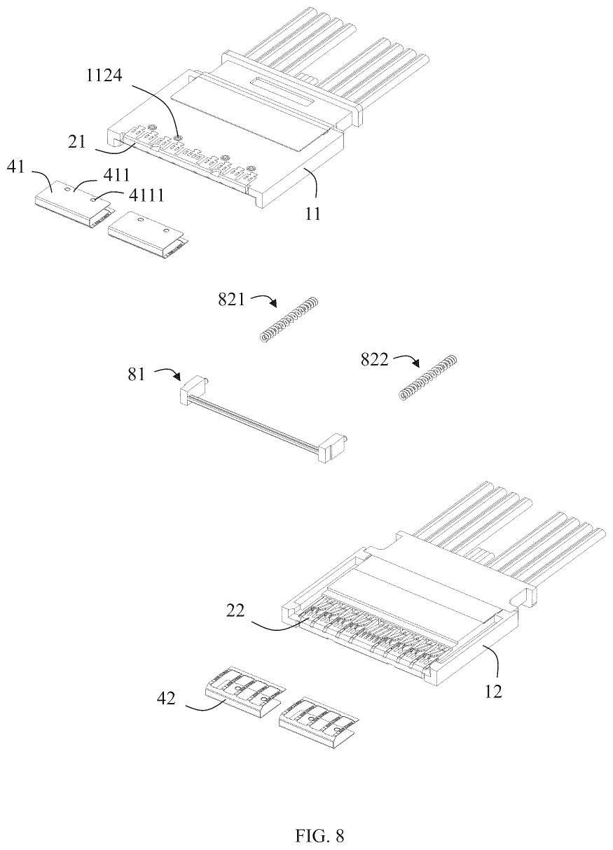

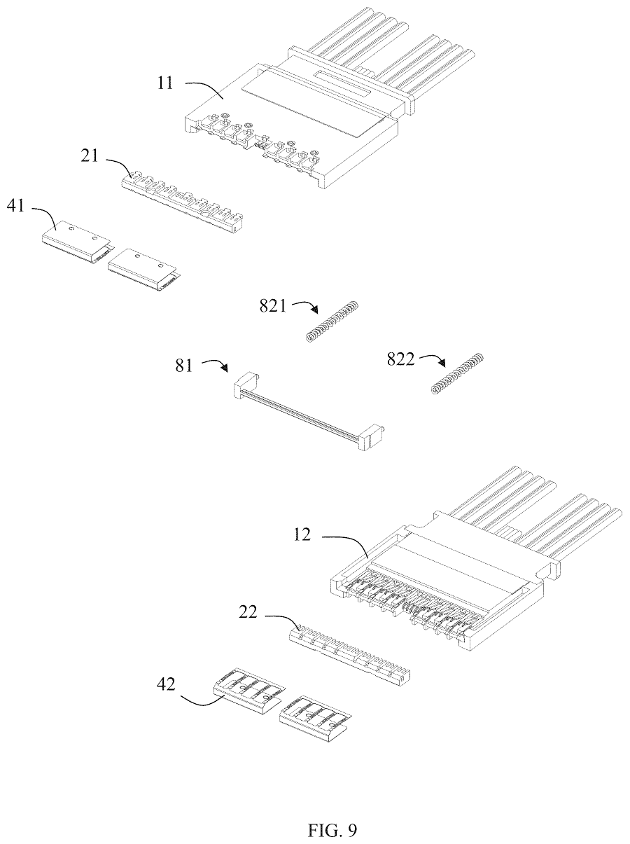

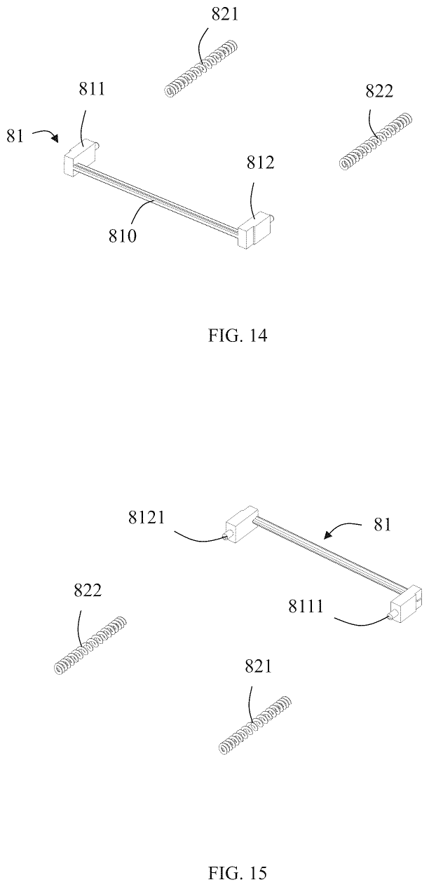

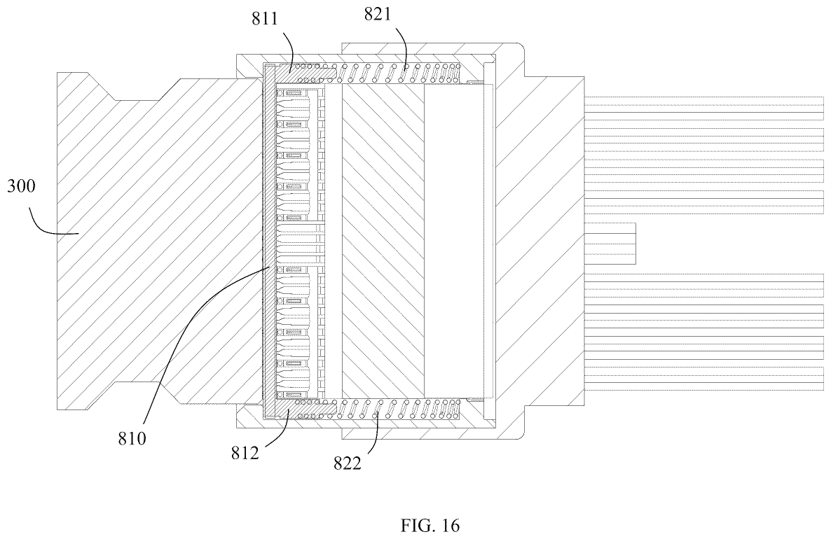

Referring to FIG. 1 to FIG. 20, in the illustrated embodiment of the present disclosure, the electrical connector 100 includes a first module M1, a second module M2 and an outer insulating housing 9 fixed on the first module M1 and the second module M2. The first module M1 and the second module M2 are separately arranged and fixed together.

In one embodiment of the present disclosure, the electrical connector 100 includes a housing 1, a terminal protection device 8 mounted to the housing 1, and a plurality of conductive terminals 3 mounted to the housing 1.

In an embodiment of the present disclosure, the housing 1 is a conductive housing. The conductive housing is a metal housing made of metal material so as to further improve the shielding effect and improve the quality of signal transmission. In another embodiment of the present disclosure, the conductive housing may also be a composite housing formed by electroplating a metal material on an insulating material. The composite housing can also improve the shielding effect and improve the quality of signal transmission.

In an embodiment of the present disclosure, the housing 1 includes a first housing 11 and a second housing 12. The first housing 11 is a first conductive housing, and the second housing 12 is a second conductive housing. The first housing 11 and the second housing 12 are fixed together. For example, after the first housing 11 and the second housing 12 are assembled, they are fixed together for example by welding or soldering or other methods. In the illustrated embodiment of the present disclosure, the first housing 11 of the first module M1 and the second housing 12 of the second module M2 are separately arranged and fixed together to jointly form the receiving slot 101.

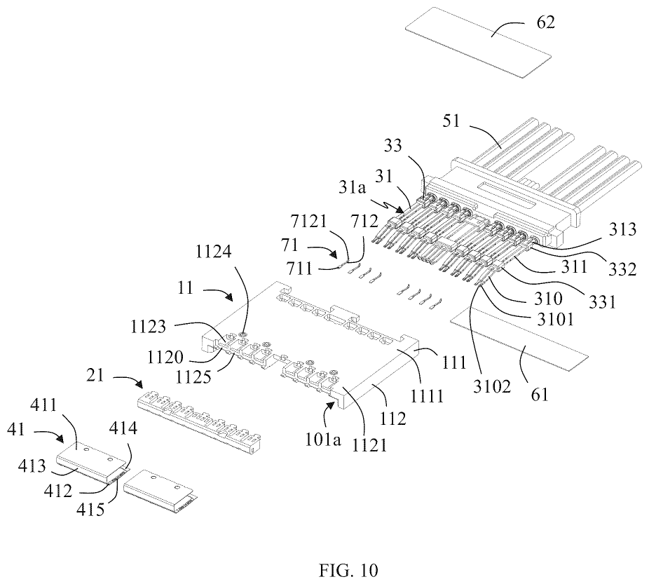

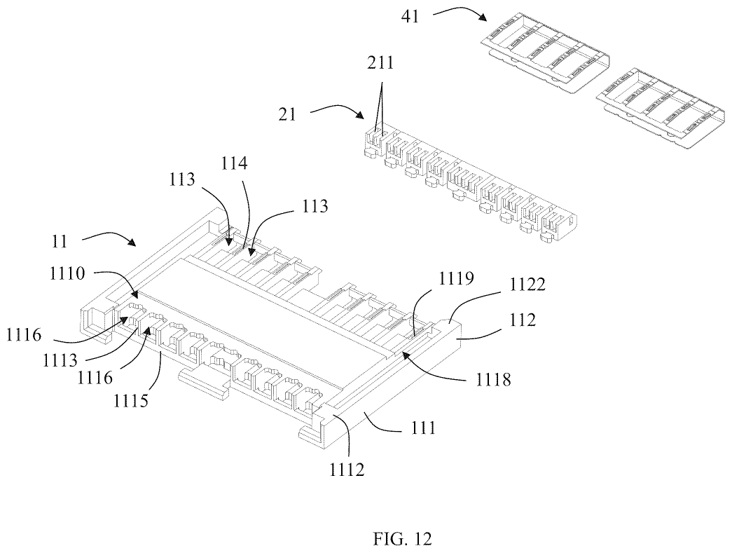

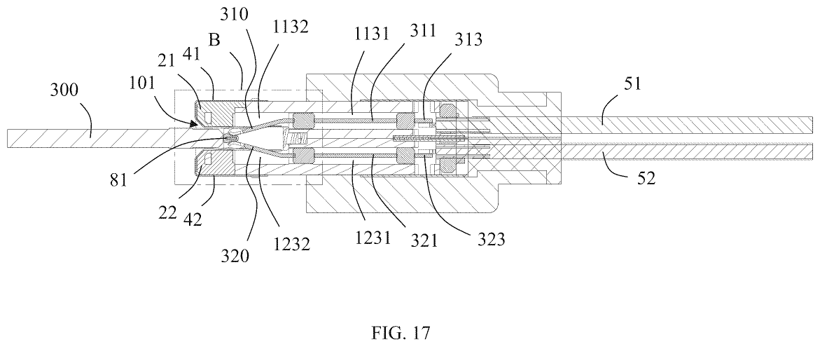

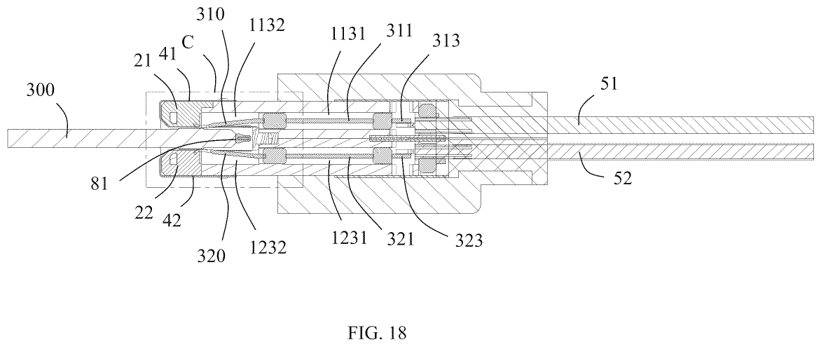

Referring to FIG. 10, FIG. 12, FIG. 17 and FIG. 18, in an embodiment of the present disclosure, the first housing 11 includes a first base portion 111 and a first protruding portion 112 extending forwardly from the first base portion 111. In the illustrated embodiment of the present disclosure, the first base portion 111 and the first protruding portion 112 have the same width. The first base portion 111 includes a first upper surface 1111, a first lower surface 1112, a first rear surface 1115 and a plurality of first mounting grooves 1116 recessed forwardly from the first rear surface 1115. The plurality of first mounting grooves 1116 are spaced apart along the third direction A3-A3. Besides, the plurality of first mounting grooves 1116 extend downwardly through the first lower surface 1112. In the illustrated embodiment of the present disclosure, the first base portion 111 is further provided with a plurality of first barrier portions 1113. Any two adjacent first mounting grooves 1116 are separated by one first barrier portion 1113 located between the two first mounting grooves 1116 so as to improve the shielding effect and improve the quality of signal transmission. The first base portion 111 further defines a first mounting recess 1110 formed upwardly from the first lower surface 1112. Specifically, in the illustrated embodiment of the present disclosure, the first mounting grooves 1116 extend backwardly through the first rear surface 1115. The first mounting grooves 1116 communicate downwardly with the first mounting recess 1110. Besides, a bottom of the first base portion 111 further includes at least one first recess 1118 adjacent to the first protruding portion 112.

Referring to FIG. 10 and FIG. 12, the first protruding portion 112 includes a second upper surface 1121, a second lower surface 1122, and a plurality of first mounting openings 1123 extending upwardly through the second upper surface 1121 along the second direction A2-A2. The first mounting opening 1123 does not completely extend forwardly through the first front end surface 1120 of the first protruding portion 112 along the first direction A1-A1. In other words, the first protruding portion 112 is provided with a first beam portion 1125 located at a front end of the first mounting opening 1123 to improve the structural strength of the first protruding portion 112. An upper surface of the first beam portion 1125 is lower than the second upper surface 1121 of the first protruding portion 112. The first protruding portion 112 further includes a plurality of first positioning posts 1124 protruding upwardly from the second upper surface 1121 along the second direction A2-A2. In addition, the first housing 11 further includes a first receiving slot 101a extending through the first front end surface 1120 along the first direction A1-A1. The first mounting opening 1123 is in communication with the first receiving slot 101a. The first receiving slot 101a is configured to at least partially receive the mating module 300.

In the illustrated embodiment of the present disclosure, the first housing 11 further includes a plurality of first terminal module accommodating slots 113 extending along the first direction A1-A1. The first mounting opening 1123 is located at one end (for example, a front end) of the first terminal module accommodating slot 113. Each first terminal module accommodating slot 113 extends from a portion of the first base portion 111 to the first protruding portion 112. A rear end of the first terminal module accommodating slot 113 communicates with the first mounting groove 1116. A middle portion of the first terminal module accommodating slot 113 is circumferentially surrounded by walls of the first housing 11. A front end of the first terminal module accommodating slot 113 extends downwardly through the second lower surface 1122. Specifically, in the illustrated embodiment of the present disclosure, the first terminal module accommodating slot 113 includes a first surrounding groove 1131 close to a corresponding first mounting groove 1116 and a first open slot 1132 away from the corresponding first mounting groove 1116. The first surrounding groove 1131 is surrounded by wall portions of the first housing 11 along a circumferential direction. The first open slot 1132 communicates with the receiving slot 101. It is understandable to those skilled in the art that by arranging the middle portion of the first terminal module accommodating slot 113 to be surrounded by the wall portions of the first housing 11 in a circumferential direction, on the one hand, the conductive terminals located in the first terminal module accommodating slots 113 can be better shielded; and on the other hand, adjacent first terminal module accommodating slots 113 can be well separated, thereby reducing signal crosstalk.

The plurality of first terminal module accommodating slots 113 are spaced apart along the third direction A3-A3. The first housing 11 includes a plurality of first partition walls 114 disposed at intervals along the third direction A3-A3. Two adjacent first terminal module accommodating slots 113 are separated by a corresponding first partition wall 114 along the third direction A3-A3. In other words, each first terminal module accommodating slot 113 is surrounded by four walls of the first housing 11 on a length corresponding to the corresponding first partition wall 114, thereby improving the shielding effect. With this arrangement, each first terminal module accommodating slot 113 is relatively independent, thereby reducing signal crosstalk and improving the quality of data transmission.

The first module M1 further includes a first insulating block 21 fixed in the first mounting opening 1123. The first insulating block 21 defines a plurality of first slits 211.

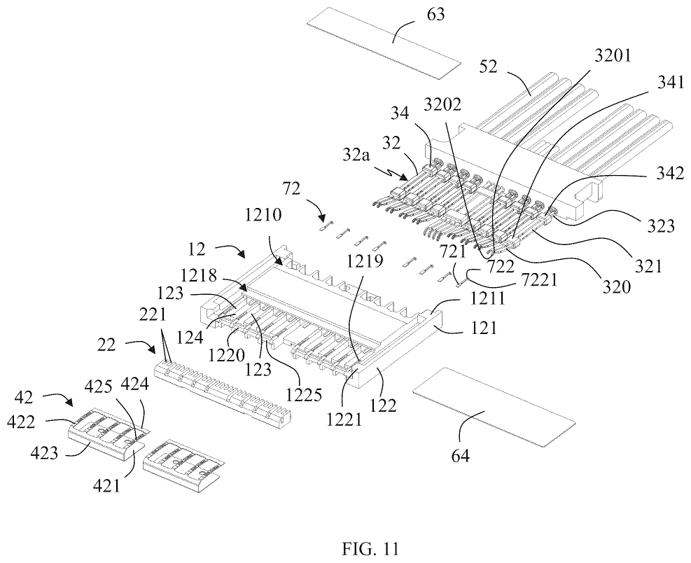

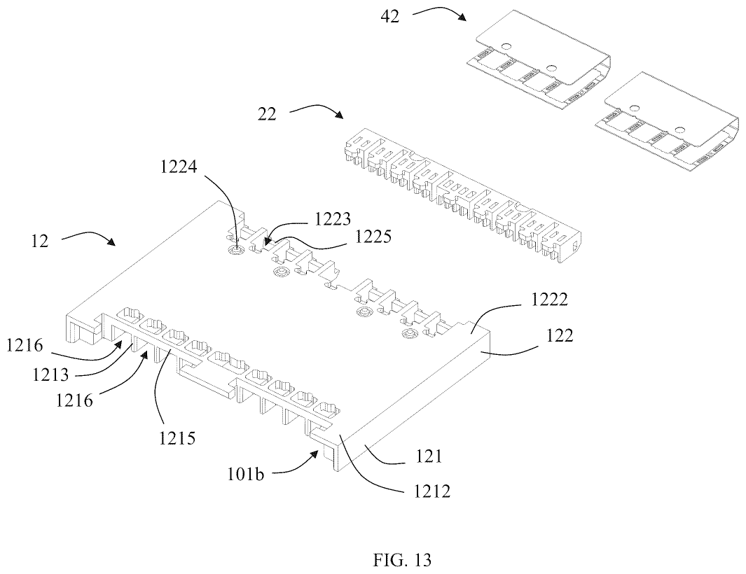

Referring to FIG. 11, FIG. 13, FIG. 17 and FIG. 18, in an embodiment of the present disclosure, the second housing 12 includes a second base portion 121 and a second protruding portion 122 extending forwardly from the second base portion 121. The second base portion 121 includes a third upper surface 1211, a third lower surface 1212, a second rear surface 1215 and a plurality of second mounting grooves 1216 recessed forwardly from the second rear surface 1215. The plurality of second mounting grooves 1216 are spaced apart along the third direction A3-A3. The plurality of second mounting grooves 1216 extend through the second base portion 121 along the top-bottom direction. The plurality of second mounting grooves 1216 extend upwardly through the third upper surface 1211. In the illustrated embodiment of the present disclosure, the second base portion 121 is further provided with a plurality of second barrier portions 1213. Any two adjacent second mounting grooves 1216 are separated by one second barrier portion 1213 located between the two second mounting grooves 1216 to improve the shielding effect and improve the quality of signal transmission. The second base portion 121 further defines a second mounting recess 1210 formed downwardly from the third upper surface 1211. Specifically, in the illustrated embodiment of the present disclosure, the second mounting grooves 1216 extend backwardly through the second rear surface 1215. The second mounting grooves 1216 upwardly communicate with the second mounting recess 1210. The second mounting recess 1210 extends upwardly through the third upper surface 1211. Besides, a top of the second base portion 121 further defines at least one second recess 1218 adjacent to the second protruding portion 122.

Referring to FIG. 11 and FIG. 13, the second protruding portion 122 includes a fourth upper surface 1221, a fourth lower surface 1222, and a plurality of second mounting openings 1223 extending downwardly through the fourth lower surface 1222. The second mounting opening 1223 does not completely extend forwardly through the second front end surface 1220 of the second protruding portion 122. In other words, the second protruding portion 122 is provided with a second beam portion 1225 located at a front end of the second mounting opening 1223 to improve the structural strength of the second protruding portion 122. A lower surface of the second beam portion 1225 is higher than the fourth lower surface 1222 of the second protruding portion 122. The second protruding portion 122 further includes a plurality of second positioning posts 1224 protruding downwardly from the second lower surface 1122. In addition, the second housing 12 further includes a second receiving slot 101b extending through the second front end surface 1220 along the first direction A1-A1. The second mounting opening 1223 is in communication with the second receiving slot 101b. The second receiving slot 101b is configured to at least partially receive the mating module 300.

In the illustrated embodiment of the present disclosure, the second housing 12 further includes a plurality of second terminal module accommodating slots 123 extending along the first direction A1-A1. The second mounting opening 1223 is located at one end (for example, a front end) of the second terminal module accommodating slot 123. Each second terminal module accommodating slot 123 extends from the second base portion 121 to the second protruding portion 122. A rear end of the second terminal module accommodating slot 123 communicates with the second mounting groove 1216. The middle portion of the second terminal module accommodating slot 123 is circumferentially surrounded by walls of the second housing 12. A front end of the second terminal module accommodating slot 123 extends upwardly through the fourth upper surface 1221. Specifically, in the illustrated embodiment of the present disclosure, the second terminal module accommodating slot 123 includes a second surrounding groove 1231 close to a corresponding second mounting groove 1216 and a second open slot 1232 away from the corresponding second mounting groove 1216. The second surrounding groove 1231 is surrounded by wall portions of the second housing 12 along a circumferential direction. The second open slot 1232 communicates with the receiving slot 101. It is understandable to those skilled in the art that by arranging the middle portion of the second terminal module accommodating slot 123 to be surrounded by the wall portions of the second housing 12 in a circumferential direction; on the one hand, the conductive terminals located in the second terminal module accommodating slots 123 can be better shielded; and on the other hand, the adjacent second terminal module accommodating slots 123 can be well separated, thereby reducing signal crosstalk.

The plurality of second terminal module accommodating slots 123 are arranged at intervals along the third direction A3-A3. The second housing 12 includes a plurality of second partition walls 124 disposed at intervals along the third direction A3-A3. Two adjacent second terminal module accommodating slots 123 are separated by corresponding second partition walls 124 along the third direction A3-A3. In other words, each second terminal module accommodating slot 123 is surrounded by four walls of the second housing 12 on a length corresponding to the second partition wall 124, thereby improving the shielding effect. With this arrangement, each second terminal module accommodating slot 123 is relatively independent, thereby reducing signal crosstalk and improving the quality of data transmission.

The second module M2 further includes a second insulating block 22 fixed in the second mounting opening 1223. The second insulating block 22 defines a plurality of second slits 221.

The plurality of conductive terminals 3 include a plurality of first conductive terminals 31 and a plurality of second conductive terminals 32. Each first conductive terminal 31 includes a first fixing portion 311 extending along the first direction A1-A1, a first elastic contact arm 310 extending forwardly from a front end of the first fixing portion 311, and a first tail portion 313 extending backwardly from a rear end of the first fixing portion 311. The first fixing portion 311 is at least partially located in the first surrounding groove 1131. The first elastic contact arm 310 is at least partially located in the first open slot 1132. The first tail portion 313 is at least partially located in the first mounting groove 1116. The first elastic contact arm 310 includes a first contact portion 3101 that passes through the first open slot 1132 and extends into the first receiving slot 101a. The first contact portions 3101 are configured to be in contact with the first signal contact pads 3041 of the tongue plate 301. In the illustrated embodiment of the present disclosure, the first tail portions 313 extend backwardly and horizontally to be electrically connected to first cables 51. In addition, the first elastic contact arm 310 further includes a first distal end portion 3102 extending from the first contact portion 3101. The first distal end portion 3102 of the first conductive terminal 31 is received in the first slit 211 when the first elastic contact arm 310 is elastically deformed. In the illustrated embodiment of the present disclosure, a length of the first distal end portion 3102 is short in order to improve resonance and improve the quality of signal transmission.

In the illustrated embodiment of the present disclosure, the plurality of first conductive terminals 31 are divided into a plurality of groups. Each group of first conductive terminals 31 includes a first signal terminal S1 and a second signal terminal S2 located adjacent to the first signal terminal S1. Preferably, the first signal terminal S1 and the second signal terminal S2 in each group of first conductive terminals 31 form a differential pair to improve signal transmission speed, thereby being suitable for high-speed signal transmission.

In the illustrated embodiment of the present disclosure, the electrical connector 100 further includes a first holding block 33 fixed on the first signal terminal S1 and the second signal terminal S2 of each group of first conductive terminals 31. In an embodiment of the present disclosure, the first signal terminal S1 and the second signal terminal S2 are insert-molded with the first holding block 33, so as to form an integrated first terminal module 31a. The first contact portions 3101 of the first signal terminal S1 and the second signal terminal S2 in each first terminal module 31a are configured to be in contact with the first signal contact pads 3041 of the mating module 300, respectively. The first terminal module 31a is at least partially disposed (for example, assembled) in the first terminal module accommodating slot 113.

In the illustrated embodiment of the present disclosure, the first holding block 33 includes a first fixing block 331 fixed on middle portions of the first fixing portions 311 of the first signal terminal S1 and the second signal terminal S2, and a second fixing block 332 fixed on rear ends of the first fixing portions 311 of the first signal terminal S1 and the second signal terminal S2. The first fixing block 331 and the second fixing block 332 are installed and fixed in the first terminal module accommodating slot 113, which prevents the first conductive terminal 31 from contacting the first housing 11 to cause a short circuit. The first tail portion 313 extends backwardly into the first mounting groove 1116 to facilitate connection with the first cable 51.

Similarly, each second conductive terminal 32 includes a second fixing portion 321 extending along the first direction A1-A1, a second elastic contact arm 320 extending forwardly from a front end of the second fixing portion 321, and a second tail portion 323 extending backwardly from a rear end of the second fixing portion 321. The second fixing portion 321 is at least partially located in the second surrounding groove 1231. The second elastic contact arm 320 is located at least partially in the second open slot 1232. The second tail portion 323 is at least partially located in the second mounting groove 1216. The second elastic contact arm 320 includes a second contact portion 3201 that passes through the second open slot 1232 and extends into the second receiving slot 101b. The second contact portions 3201 are configured to be in contact with the second signal contact pads 3051 of the tongue plate 301. In the illustrated embodiment of the present disclosure, the second tail portions 323 extend backwardly and horizontally from the second fixing portions 321 to be electrically connected to second cables 52. In addition, the second elastic contact arm 320 further includes a second distal end portion 3202 extending from the second contact portion 3201. The second distal end portion 3202 of the second conductive terminal 32 is received in the second slit 221 when the second elastic contact arm 320 is elastically deformed. In the illustrated embodiment of the present disclosure, a length of the second distal end portion 3202 is short in order to improve resonance and improve the quality of signal transmission. Besides, the provision of the slider 81 reduces the risk that the first distal end portion 3102 and the second distal end portion 3202 are easily damaged by foreign objects after their lengths are shortened, thereby improving reliability.

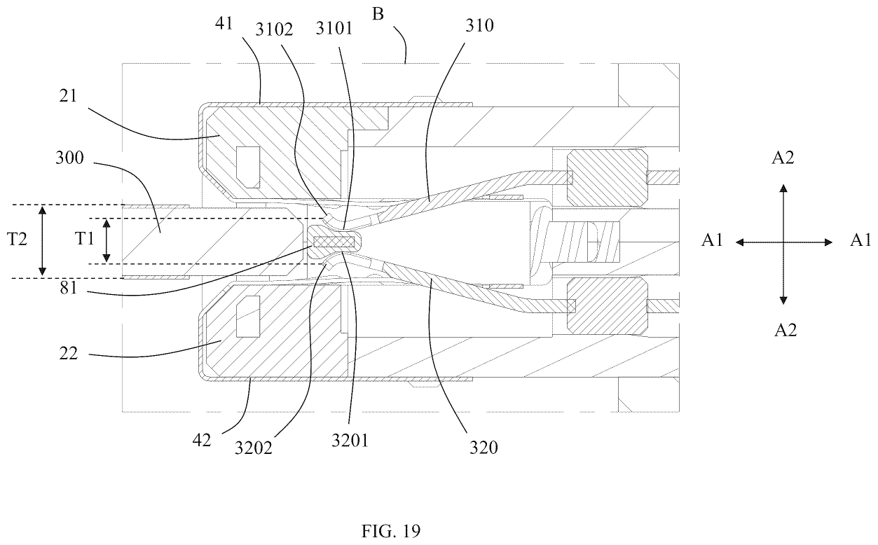

As shown in FIG. 19, in the illustrated embodiment of the present disclosure, after the lengths of the first distal end portion 3102 and the second distal end portion 3202 are shortened, a distance T1 between a lower sharp corner of the first distal end portion 3102 and an upper sharp corner of the second distal end portion 3202 along the second direction A2-A2 is smaller than a thickness T2 of the tongue plate 301 along the second direction A2-A2. It is understandable to those skilled in the art that such designs are often dangerous, because once the tongue plate 301 is inserted slightly obliquely, it is easy for a front end surface of the tongue plate 301 to directly abuts against the first distal end portion 3102 and/or the second distal end portion 3202, causing the first distal end portion 3102 and/or the second distal end portion 3202 to be damaged. In the illustrated embodiment of the present disclosure, the above problem is well solved by providing a slider 81 (described in detail later).

In the illustrated embodiment of the present disclosure, the plurality of second conductive terminals 32 are divided into a plurality of groups, and each group of second conductive terminals 32 includes a third signal terminal S3 and a fourth signal terminal S4 located adjacent to the third signal terminal S3. Preferably, the third signal terminal S3 and the fourth signal terminal S4 in each group of second conductive terminals 32 form a differential pair to improve signal transmission speed, thereby being suitable for high-speed signal transmission.

In the illustrated embodiment of the present disclosure, the electrical connector 100 further includes a second holding block 34 fixed on the third signal terminal S3 and the fourth signal terminal S4 of each group of second conductive terminals 32. In one embodiment of the present disclosure, the third signal terminal S3 and the fourth signal terminal S4 are insert-molded with the second holding block 34 to form an integrated second terminal module 32a. The second contact portions 3201 of the third signal terminal S3 and the fourth signal terminal S4 in each second terminal module 32a are configured to be in contact with the second signal contact pads 3051 of the mating module 300. The second terminal module 32a is at least partially disposed (for example, assembled) in the second terminal module accommodating slot 123.

In the illustrated embodiment of the present disclosure, the second holding block 34 includes a third fixing block 341 fixed at middle portions of the second fixing portions 321 of the third signal terminal S3 and the fourth signal terminal S4, and a fourth fixing block 342 fixed at rear ends of the second fixing portions 321 of the third signal terminal S3 and the fourth signal terminal S4. The third fixing block 341 and the fourth fixing block 342 are installed and fixed in the second terminal module accommodating slot 123, which prevents the second conductive terminal 32 from contacting the second housing 12 to cause a short circuit. The second tail portions 323 extend backwardly into the second mounting grooves 1216 to facilitate connection with the second cables 52.

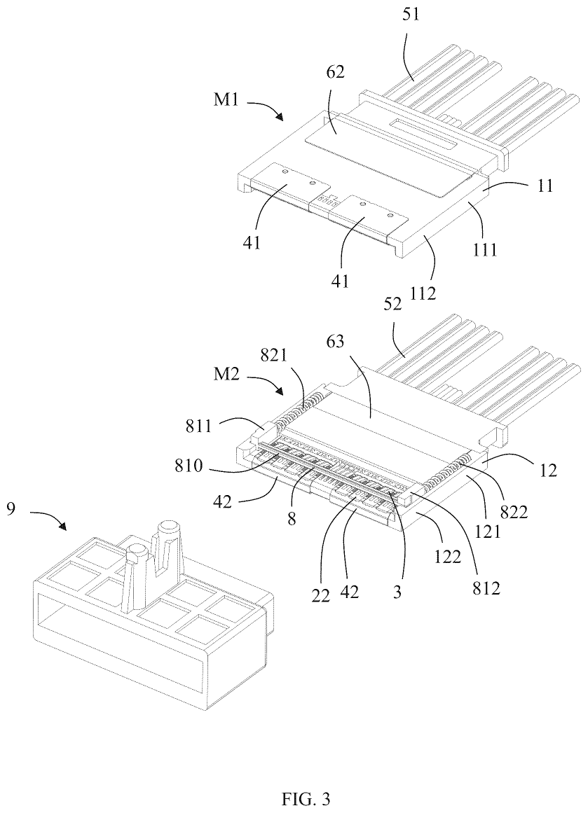

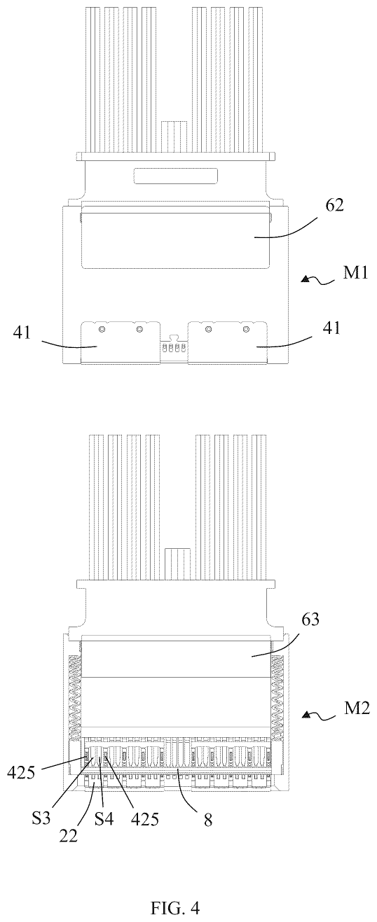

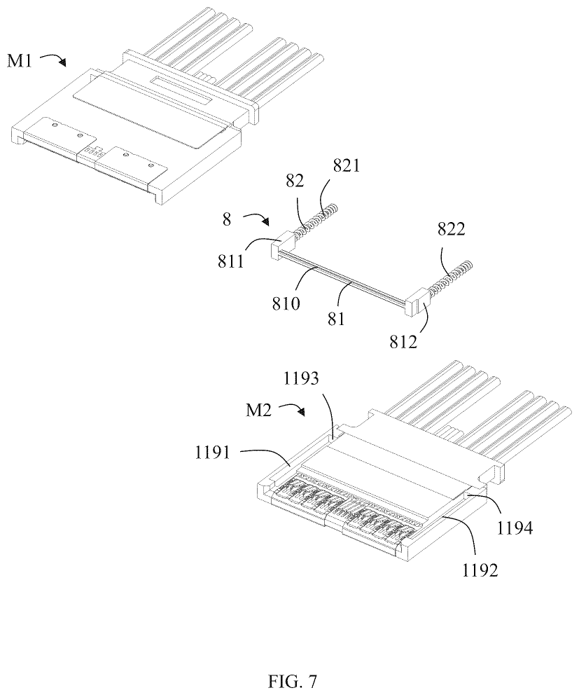

Referring to FIG. 3, FIG. 4, FIG. 7 to FIG. 9, and FIG. 16 to FIG. 20, in the illustrated embodiment of the present disclosure, the terminal protection device 8 includes a slider 81 and an elastic element 82 that cooperates with the slider 81. The elastic element 82 is configured to provide a restoring force for restoring the slider 81. The slider 81 is configured to be pushed by the mating module 300 to move in the receiving slot 101 along the first direction A1-A1. The slider 81 is located between the first elastic contact arm 310 and the second elastic contact arm 320. The slider 81 is configured to abut against the first elastic contact arm 310 and the second elastic contact arm 320 when the mating module 300 is inserted into the receiving slot 101, so that the first elastic contact arm 310 and the second elastic contact arm 320 are elastically deformed in directions away from each other, and the first contact portion 3101 and the second contact portion 3201 are brought into contact with the mating module 300 to achieve electrical connection.

In the illustrated embodiment of the present disclosure, the elastic element 82 includes a first compression spring 821 and a second compression spring 822.

The slider 81 includes an abutting portion 810, a first protruding block 811 connected to one end of the abutting portion 810, and a second protruding block 812 connected to another end of the abutting portion 810. The first protruding block 811 is provided with a first protruding post 8111. The second protruding block 812 is provided with a second protruding post 8121.

The first housing 11 and/or the second housing 12 are provided with a first receiving groove 1191 for receiving the first compression spring 821, a second receiving groove 1192 for receiving the second compression spring 822, a first abutting surface 1193 exposed in the first receiving groove 1191 and a second abutting surface 1194 exposed in the second receiving groove 1192. One end of the first compression spring 821 abuts against the first protruding block 811. One end of the second compression spring 822 abuts against the second protruding block 812. Specifically, one end of the first compression spring 821 is sleeved on the first protruding post 8111, and the other end of the first compression spring 821 abuts against the first abutting surface 1193. One end of the second compression spring 822 is sleeved on the second protruding post 8121, and the other end of the second compression spring 822 abuts against the second abutting surface 1194.

In the illustrated embodiment of the present disclosure, the first housing 11 and the second housing 12 jointly form the first receiving groove 1191 for receiving the first compression spring 821, jointly form the second receiving groove 1192 for receiving the second compression spring 822, jointly form the first contact surface 1193 exposed in the first receiving groove 1191, and jointly form the second contact surface 1194 exposed in the second receiving groove 1192. With this arrangement, the first module M1 and the second module M2 can be shared parts in order to save costs.

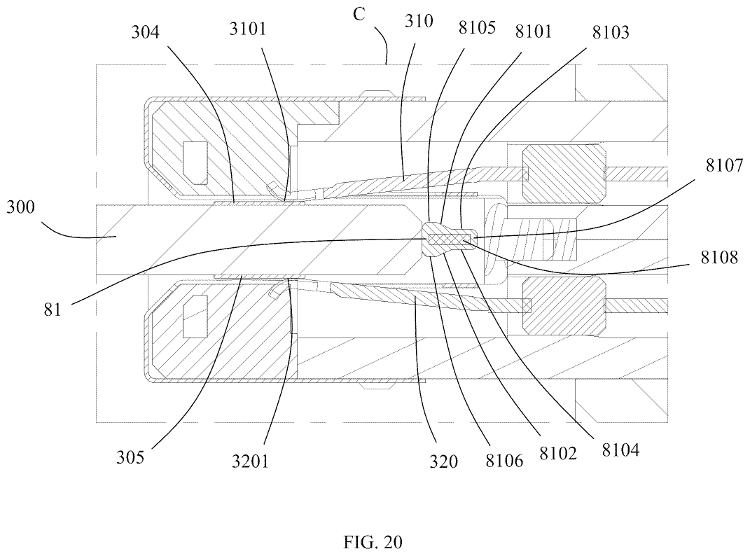

Referring to FIG. 20, in the illustrated embodiment of the present disclosure, the abutting portion 810 includes a first guide inclined surface 8101 configured to abut against the first elastic contact arm 310 and a second guide inclined surface 8102 configured to abut against the second elastic contact arm 320.

In addition, the abutting portion 810 includes a first flat surface 8103 connected to one end of the first guide inclined surface 8101 and a second flat surface 8104 connected to one end of the second guide inclined surface 8102. A distance between the first flat surface 8103 and the second flat surface 8104 is smaller than a distance between the first guide inclined surface 8101 and the second guide inclined surface 8102. When the slider 81 is in an initial position, the first contact portion 3101 abuts against the first flat surface 8103, and the second contact portion 3201 abuts against the second flat surface 8104.

The abutting portion 810 includes a third flat surface 8105 connected to the other end of the first guide inclined surface 8101 and a fourth flat surface 8106 connected to the other end of the second guide inclined surface 8102. A distance between the third flat surface 8105 and the fourth flat surface 8106 is greater than the distance between the first guide inclined surface 8101 and the second guide inclined surface 8102.

When the mating module 300 is inserted into the receiving slot 101 and the slider 81 is pushed to move, the first contact portion 3101 crosses the first guide inclined surface 8101 and the third flat surface 8105, and is then in contact with the mating module 300 to achieve electrical connection; the second contact portion 3201 crosses the second guide inclined surface 8102 and the fourth flat surface 8106, and is then in contact with the mating module 300 to achieve electrical connection.

In the illustrated embodiment of the present disclosure, the abutting portion 810 includes an insulating block 8107 and a reinforcing element 8108 embedded in the insulating block 8107. The first guide inclined surface 8101 and the second guide inclined surface 8102 are both provided on the insulating block 8107.

In one embodiment of the present disclosure, the electrical connector 100 further includes at least one ground sheet 4 mounted to the housing 1. The ground sheet 4 includes a first ground sheet 41 and a second ground sheet 42. In the illustrated embodiment of the present disclosure, two first ground sheets 41 are provided and they are made of metal material. Two second ground sheets 42 are provided and they are made of metal material.

Each first ground sheet 41 is generally U-shaped and includes a first mounting plate 411, a second mounting plate 412 opposite to the first mounting plate 411, a first connecting plate 413 connecting one side of the first mounting plate 411 and one side of the second mounting plate 412, and a first extension plate 414 extending downwardly and backwardly from another side of the second mounting plate 412. The first mounting plate 411 defines a plurality of first mounting positioning holes 4111 that match the first positioning posts 1124. The first extension plate 414 is received in a corresponding first recess 1118 of the first housing 11.

The first connecting plate 413 is located at a front end of the receiving slot 101 along the first direction A1-A1. When the mating module 300 is inserted, the tongue plate 301 may be in contact with the first connecting plate 413 first, thereby facilitating the discharge of static electricity. The second mounting plate 412 is provided with a plurality of first ground elastic arms 415 which are disposed at intervals along the third direction A3-A3. The first ground elastic arms 415 are disposed on two sides of the first elastic contact arms 310 of each group of first conductive terminals 31 so as to improve the shielding effect and improve the quality of signal transmission.

In an embodiment of the present disclosure, the first positioning posts 1124 are fixed to the first mounting positioning holes 4111, so that the first mounting plate 411 is fixed to the second upper surface 1121 of the first protruding portion 112.

Each second ground sheet 42 is generally U-shaped and includes a third mounting plate 421, a fourth mounting plate 422 opposite to the third mounting plate 421, a second connecting plate 423 connecting one side of the third mounting plate 421 and one side of the fourth mounting plate 422, and a second extension plate 424 extending downwardly and backwardly from another side of the fourth mounting plate 422. The third mounting plate 421 defines a plurality of second mounting positioning holes 4211 that match the second positioning posts 1224. The second extension plate 424 is received in a corresponding second recess 1218 of the second housing 12.

The second connecting plate 423 is located at the front end of the receiving slot 101 along the first direction A1-A1. When the mating module 300 is inserted, the tongue plate 301 may be in contact with the second connecting plate 423 first, thereby facilitating the discharge of static electricity. The fourth mounting plate 422 is provided with a plurality of second ground elastic arms 425 which are disposed at intervals along the third direction A3-A3. The second ground elastic arms 425 are disposed on two sides of the second elastic contact arms 320 of each group of second conductive terminals 32, respectively, so as to improve the shielding effect and improve the quality of signal transmission.

In an embodiment of the present disclosure, the second positioning posts 1224 are fixed in the second mounting positioning holes 4211, so that the third mounting plate 421 is fixed to the fourth lower surface 1222 of the second protruding portion 122.

A gap is formed between the first housing 11 and the first ground elastic arm 415 when the first ground elastic arm 415 protrudes into the first receiving slot 101a, and signal crosstalk is easily generated in this gap. Similarly, another gap is formed between the second housing 12 and the second ground elastic arm 425 when the second ground elastic arm 425 protrudes into the second receiving slot 101b, and signal crosstalk is easily generated in the another gap.

In order to improve signal crosstalk, in the illustrated embodiment of the present disclosure, the first module M1 further includes a first ground terminal 71 located between the first ground elastic arm 415 and the first housing 11 along the second direction A2-A2. The second module M2 further includes a second ground terminal 72 located between the second ground elastic arm 425 and the second housing 12 along the second direction A2-A2.

The first ground terminal 71 includes a first mounting portion 711 abutting against the first housing 11 and a first abutting elastic arm 712 extending from the first mounting portion 711. The first abutting elastic arm 712 is in contact with the first ground elastic arm 415. The first housing 11 defines a first relief groove 1119 into which a free end 7121 of the first abutting elastic arm 712 protrudes.

Similarly, the second ground terminal 72 includes a second mounting portion 721 abutting against the second housing 12 and a second abutting elastic arm 722 extending from the second mounting portion 721. The second abutting elastic arm 722 is in contact with the second ground elastic arm 425. The second housing 12 defines a second relief groove 1219 into which a free end 7221 of the second abutting elastic arm 722 protrudes.

In the illustrated embodiment of the present disclosure, the first module M1 further includes a first shielding plate 61 installed on the first housing 11 and a first shielding cover 62 installed on the first housing 11. In an embodiment of the present disclosure, the first shielding plate 61 is a metal shielding plate, and the first shielding cover 62 is a metal shielding cover. The first shielding plate 61 is installed in the first mounting recess 1110. By installing the first shielding plate 61, the downwardly open first mounting grooves 1116 can be better shielded, thereby improving the shielding effect.

In the illustrated embodiment of the present disclosure, the second module M2 further includes a second shielding plate 63 installed on the second housing 12 and a second shielding cover 64 installed on the second housing 12. In an embodiment of the present disclosure, the second shielding plate 63 is a metal shielding plate, and the second shielding cover 64 is a metal shielding cover. The second shielding plate 63 is installed in the second mounting recess 1210. By installing the second shielding plate 63, the downwardly open second mounting grooves 1216 can be better shielded, thereby improving the shielding effect.

When the mating module 300 is not inserted into the receiving slot 101, the slider 81 is in the initial position under the restoring force of the elastic element 82. The initial position is disposed adjacent to an insertion surface of the receiving slot 101.

Referring to FIG. 16 to FIG. 20, when in use, the mating module 300 is at least partially inserted into the receiving slot 101. The tongue plate 301 of the mating module 300 will push the slider 81 to move backwardly. When the slider 81 moves backward, it will spread the first elastic contact arm 310 and the second elastic contact arm 320 outward. Therefore, on the one hand, the mating module 300 can be inserted into the receiving slot 101, and on the other hand, the mating module 300 can be prevented from colliding with the first distal end portion 3102 and the second distal end portion 3202, and causing damage to the conductive terminals. With such an arrangement, on the one hand, the resonance can be improved by shortening the lengths of the first distal end portion 3102 and the second distal end portion 3202, thereby improving the quality of signal transmission. On the other hand, the provision of the slider 81 reduces the risk that the first distal end portion 3102 and the second distal end portion 3202 are easily damaged by foreign objects after their lengths are shortened, thereby improving reliability.

When the mating module 300 is inserted into the receiving slot 101 and inserted in position, the slider 81 is pushed backwardly by the mating module 300 (as shown in FIG. 20). At this time, the elastic element 82 is in a compressed state. When the mating module 300 is pulled out of the receiving slot 101, the elastic element 82 resets to push the slider 81 to move forwardly to an initial state (as shown in FIG. 19).

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a housing, the housing defining a receiving slot which extends along a first direction and is configured to at least partially receive a mating module;
a first terminal module, the first terminal module being at least partially disposed on the housing, the first terminal module comprising a plurality of first conductive terminals, each first conductive terminal comprising a first elastic contact arm, the first elastic contact arm comprising a first contact portion configured to be in contact with the mating module;
a second terminal module, the second terminal module being at least partially disposed on the housing, the second terminal module comprising a plurality of second conductive terminals, each second conductive terminal comprising a second elastic contact arm, the second elastic contact arm comprising a second contact portion configured to be in contact with the mating module; the first contact portion and the second contact portion protruding into the receiving slot; and
a slider, the slider being located between the first elastic contact arm and the second elastic contact arm, the slider being configured to abut against the first elastic contact arm and the second elastic contact arm when the mating module is inserted into the receiving slot, so that the first elastic contact arm and the second elastic contact arm deform elastically in directions away from each other, and the first contact portion and the second contact portion are brought into contact with the mating module to achieve electrical connection.

2. The electrical connector according to claim 1, further comprising an elastic element for mating with the slider, the elastic element being configured to provide a restoring force for restoring the slider.

3. The electrical connector according to claim 2, wherein the elastic element comprises a first compression spring and a second compression spring;
the slider comprises an abutting portion, a first protruding block connected to one end of the abutting portion, and a second protruding block connected to another end of the abutting portion;
the housing defines a first receiving groove to receive the first compression spring and a second receiving groove to receive the second compression spring;
one end of the first compression spring abuts against the first protruding block, and one end of the second compression spring abuts against the second protruding block.

4. The electrical connector according to claim 3, wherein the first protruding block comprises a first protruding post, and the one end of the first compression spring is sleeved on the first protruding post;
the second protruding block comprises a second protruding post, and the one end of the second compression spring is sleeved on the second protruding post.

5. The electrical connector according to claim 3, wherein the housing comprises a first abutting surface exposed in the first receiving groove and a second abutting surface exposed in the second receiving groove; another end of the first compression spring abuts against the first abutting surface, and another end of the second compression spring abuts against the second abutting surface.

6. The electrical connector according to claim 1, wherein the slider comprises an abutting portion; the abutting portion comprises a first guide inclined surface configured to abut against the first elastic contact arm and a second guide inclined surface configured to abut against the second elastic contact arm.

7. The electrical connector according to claim 6, wherein the abutting portion comprises a first flat surface connected to one end of the first guide inclined surface and a second flat surface connected to one end of the second guide inclined surface; a distance between the first flat surface and the second flat surface is smaller than a distance between the first guide inclined surface and the second guide inclined surface;
when the slider is in an initial position, the first contact portion abuts against the first flat surface, and the second contact portion abuts against the second flat surface.

8. The electrical connector according to claim 7, wherein the abutting portion comprises a third flat surface connected to another end of the first guide inclined surface and a fourth flat surface connected to another end of the second guide inclined surface; a distance between the third flat surface and the fourth flat surface is greater than the distance between the first guide inclined surface and the second guide inclined surface;
when the mating module is inserted into the receiving slot and pushes the slider to move, the first contact portion contacts the mating module to achieve electrical connection after the first contact portion crosses the first guide inclined surface and the third flat surface, and the second contact portion contacts the mating module to achieve electrical connection after the second contact portion crosses the second guide inclined surface and the fourth flat surface.

9. The electrical connector according to claim 6, wherein the abutting portion comprises an insulating block and a reinforcing element embedded in the insulating block; the first guide inclined surface and the second guide inclined surface are both provided on the insulating block.

10. The electrical connector according to claim 1, wherein the electrical connector comprises a first module and a second module; the first module comprises a first housing and the first terminal module; the first housing defines a first receiving slot;
the second module comprises a second housing and the second terminal module; the second housing defines a second receiving slot;
the housing comprises the first housing and the second housing; the first receiving slot and the second receiving slot jointly form the receiving slot.

11. The electrical connector according to claim 10, wherein the first module further comprises a first ground sheet fixed to the first housing; the first ground sheet comprises a first mounting plate, a second mounting plate disposed opposite to the first mounting plate, and a first connecting plate connecting one side of the first mounting plate and one side of the second mounting plate; the second mounting plate comprises a first ground elastic arm protruding into the first receiving slot;
the first module further comprises a first ground terminal located between the first ground elastic arm and the first housing along a second direction which is perpendicular to the first direction.

12. The electrical connector according to claim 11, wherein the first ground terminal comprises a first mounting portion abutting against the first housing and a first abutting elastic arm extending from the first mounting portion; the first abutting elastic arm is in contact with the first ground elastic arm.

13. The electrical connector according to claim 12, wherein the first housing defines a first relief groove, and a free end of the first abutting elastic arm protrudes into the first relief groove.

14. The electrical connector according to claim 10, wherein the second module further comprises a second ground sheet fixed to the second housing; the second ground sheet comprises a third mounting plate, a fourth mounting plate disposed opposite to the third mounting plate and a second connecting plate connecting one side of the third mounting plate and one side of the fourth mounting plate; the fourth mounting plate comprises a second ground elastic arm protruding into the second receiving slot;
the second module further comprises a second ground terminal located between the second ground elastic arm and the second housing along a second direction which is perpendicular to the first direction.

15. The electrical connector according to claim 14, wherein the second ground terminal comprises a second mounting portion abutting against the second housing and a second abutting elastic arm extending from the second mounting portion; the second abutting elastic arm is in contact with the second ground elastic arm.

16. The electrical connector according to claim 15, wherein the second housing defines a second relief groove, and a free end of the second abutting elastic arm protrudes into the second relief groove.

17. The electrical connector according to claim 10, wherein the first housing of the first module and the second housing of the second module are separately arranged and fixed together; the first housing is a first conductive housing; and the second housing is a second conductive housing.

18. The electrical connector according to claim 10, wherein the first module further comprises a plurality of first cables connected to the first conductive terminals;
the second module further comprises a plurality of second cables connected to the second conductive terminals.

19. An electrical connector, comprising:
a housing, the housing defining a receiving slot which extends along a first direction and is configured to at least partially receive a mating module;
a first terminal module, the first terminal module being mounted to the housing, the first terminal module comprising a plurality of first conductive terminals, each first conductive terminal comprising a first elastic contact arm, the first elastic contact arm comprising a first contact portion configured to be in contact with the mating module;
a second terminal module, the second terminal module being mounted to the housing, the second terminal module comprising a plurality of second conductive terminals, each second conductive terminal comprising a second elastic contact arm, the second elastic contact arm comprising a second contact portion configured to be in contact with the mating module; the first contact portion and the second contact portion being disposed on opposite sides of the receiving slot;
a slider, the slider being located between the first elastic contact arm and the second elastic contact arm along a second direction which is perpendicular to the first direction, the slider being configured to abut against the first elastic contact arm and the second elastic contact arm when the mating module is inserted into the receiving slot, so that the first elastic contact arm and the second elastic contact arm deform elastically in directions away from each other, and as a result, the first contact portion and the second contact portion are brought into contact with the mating module to achieve electrical connection; and
an elastic element, the elastic element being configured to abut against the slider.

20. The electrical connector according to claim 19, wherein the slider comprises an abutting portion; the abutting portion comprises a first guide inclined surface configured to abut against the first elastic contact arm and a second guide inclined surface configured to abut against the second elastic contact arm;
wherein the abutting portion comprises a first flat surface connected to one end of the first guide inclined surface and a second flat surface connected to one end of the second guide inclined surface; a distance between the first flat surface and the second flat surface is smaller than a distance between the first guide inclined surface and the second guide inclined surface;
when the slider is in an initial position, the first contact portion abuts against the first flat surface, and the second contact portion abuts against the second flat surface.
